(19) United States
(12) Patent Application Publication
(10) Pub. No.: US 2008/0055843 A1
(43) Pub. Date: Mar. 6, 2008

(54) ELECTRIONIC APPARATUS WITH ROTATABLE COVER

(75) Inventors: Lian-Tien Ke, Taipei (TW); Cheng-Yi Lee, Taipei (TW); Chao-Ming Chu, Taipei (TW); Shun-Lung Wang, Taipei (TW); Li-Yen Wang, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: ASUSTeK COMPUTER INC., Taipei (TW)

(21) Appl. No.: 11/840,988

(22) Filed: Aug. 19, 2007

(30) Foreign Application Priority Data
Aug. 30, 2006 (TW) 95131988

(51) Int. Cl. G06F 1/16

(52) U.S. Cl. 361/686

(57) ABSTRACT

An electronic apparatus including a first body, a cover, and a restoring element is provided. The first body has at least one sidewall and an opening on the sidewall. At least a part of the cover passes through the sidewall and is pivoted to the first body. When the cover is at a first position, the cover covers the opening to prevent dust from entering the opening. When the cover is at a second position, the cover exposes the opening. The restoring element is disposed in the first body and imposes an elastic force to the cover so as to rotate the cover from the first position to the second position for exposing the opening.

### CROSS-REFERENCE TO RELATED APPLICATION

This application claims the priority benefit of Taiwan application serial no. 95131988, filed Aug. 30, 2006. All disclosure of the Taiwan application is incorporated herein by reference.

### BACKGROUND OF THE INVENTION

1. Field of the Invention

The present invention relates to an electronic apparatus having a port. More particularly, the present invention relates to an electronic apparatus having a port and a rotatable cover for covering the port.

2. Description of Related Art

Many of today's electronic apparatuses, for example, notebook PCs, personal digital assistants (PDA), and cell phones, have ports (also referred to as expansion ports or expansion slots) for connecting peripheral equipments such as printer, keyboard, mouse, universal serial bus (USB) flash drive, and network equipment, so as to expand the functions of the electronic apparatuses.

A port (for example, a network cable port, modem port, parallel port, serial port, USB port, PS/2 port, video output port, removable media port for connecting an external disk or an external CD-ROM, S-video port, headset port for connecting a headset, microphone port for connecting a microphone, memory card port etc.) has a socket for plugging a peripheral equipment, so as to electrically couple the electronic apparatus and the peripheral equipment to expand the functions of the electronic apparatus. Since a port itself is a device for electrically coupling an electronic apparatus and a peripheral equipment, bad connection may be incurred if there is dust in the port. As a result, the electronic apparatus may not be able to control the peripheral equipment properly.

Presently, most ports of electronic apparatuses are exposed outside that dirt or dust is easily accumulated thereon, which may affect the proper operations of peripheral equipments. In the conventional technology, to prevent a port from being affected by dust, the electronic apparatus is pivoted with a cover and the port is protected by the cover.

Generally, the covers of electronic apparatuses are either pulled up or down to expose the port so that a plug of a peripheral equipment can be plugged in the port. However, due to the thickness and the width of the cover and the pull-up cover between the port and the plug of the peripheral equipment, the cover becomes an interference between the plug of the peripheral equipment and the port, which makes it difficult to plug the plug of the peripheral equipment into the port. Such difficulty in plugging a plug of a peripheral equipment to a port of an electronic apparatus brings inconvenience to users.

The present invention is directed to provide an electronic apparatus with a rotatable cover to resolve the foregoing problem in the conventional technology.

### SUMMARY OF THE INVENTION

Accordingly, the present invention is directed to provide an electronic apparatus with a rotatable cover to prevent the port from being befouled by dust and further to prevent bad connection between the electronic apparatus and a peripheral equipment, so that the electronic apparatus can control the peripheral equipment properly.

According to another aspect of the present invention, an electronic apparatus with a rotatable cover is provided for protecting the port of the electronic apparatus from dust, so that the port of the electronic apparatus can work properly.

According to yet another aspect of the present invention, an electronic apparatus with a rotatable cover is provided to resolve the problem in conventional technology that a cover of the electronic apparatus cumbers the plugging of a peripheral equipment to the port.

According to yet another aspect of the present invention, an electronic apparatus with a rotatable cover is provided, wherein a plug of a peripheral equipment can be easily plugged into a port of the electronic apparatus without interference, so that the electronic apparatus can be electrically coupled to the peripheral equipment conveniently.

To achieve the aforementioned and other objectives, the present invention provides an electronic apparatus with a rotatable cover. The electronic apparatus includes a first body, a cover, and a restoring element. The first body has at least one sidewall and an opening on the sidewall. At least a part of the cover passes through the sidewall and is pivoted to the first body. When the cover is at a first position, the cover covers the opening. When the cover is at a second position, the cover exposes the opening. The restoring element is disposed in the first body. The restoring element imposes an elastic force to the cover to rotate the cover from the first position to the second position.

According to an embodiment of the present invention, the opening is an electric connector opening.

According to an embodiment of the present invention, the electronic apparatus further includes a second body pivoted to the first body.

According to an embodiment of the present invention, the cover rotates along with the rotation of the second body relative to the first body.

According to an embodiment of the present invention, the cover further includes a shaft, the sidewall further includes a hole, and the shaft passes through the hole. The restoring element surrounds the shaft, and a first contact end of the restoring element is in contact with the first body, and a second contact end of the restoring element is in contact with the shaft.

According to an embodiment of the present invention, the electronic apparatus further includes at least one first gear and one second gear. The first gear fits the shaft, the second gear is disposed in the first body, and the first gear is engaged with the second gear.

According to an embodiment of the present invention, the electronic apparatus further includes a base. The first gear and the second gear are disposed on the base, and the shaft passes through at least a part of the base.

According to an embodiment of the present invention, the second gear is a gear of a damper.

According to an embodiment of the present invention, the electronic apparatus further includes an elastic strip and a button, and the shaft further includes a locking portion. The button is disposed on the first body, and a first end of the elastic strip is fixed in the first body. When the cover is at a first position, a second end of the elastic strip is at the locking portion. When the button is pressed downward from a third position to a fourth position, the button pushes the elastic strip down so that the second end of the elastic strip is released from the locking portion so that the cover is rotated to the second position.

According to an embodiment of the present invention, the restoring element is a torsional spring surrounding the shaft.

According to the present invention, the cover is pivoted to the first body so that the opening of the first body is covered by the cover and is protected from dust. Moreover, the cover can be rotated by the elastic force of the restoring element so as to expose the opening of the first body. Accordingly, the opening is either covered to be protected or exposed to be used through the rotation of the cover.

In order to make the aforementioned and other objects, features and advantages of the present invention comprehensible, a preferred embodiment accompanied with figures is described in detail below.

### BRIEF DESCRIPTION OF THE DRAWINGS

The accompanying drawings are included to provide a further understanding of the invention, and are incorporated in and constitute apart of this specification. The drawings illustrate embodiments of the invention and, together with the description, serve to explain the principles of the invention.

FIG. 1 is a side view of an electronic apparatus according to an embodiment of the present invention.

FIG. 2 is a diagram illustrating a part of the first body and the cover in FIG. 1.

FIG. 3 is an explosion diagram of the part of the first body and the cover in FIG. 2.

FIG. 4 is a cross-sectional view of the part of the first body and the cover in FIG. 2 taken along line I-I.

FIGS. 5A-5F are diagrams illustrating the operation of the cover.

### DESCRIPTION OF EMBODIMENTS

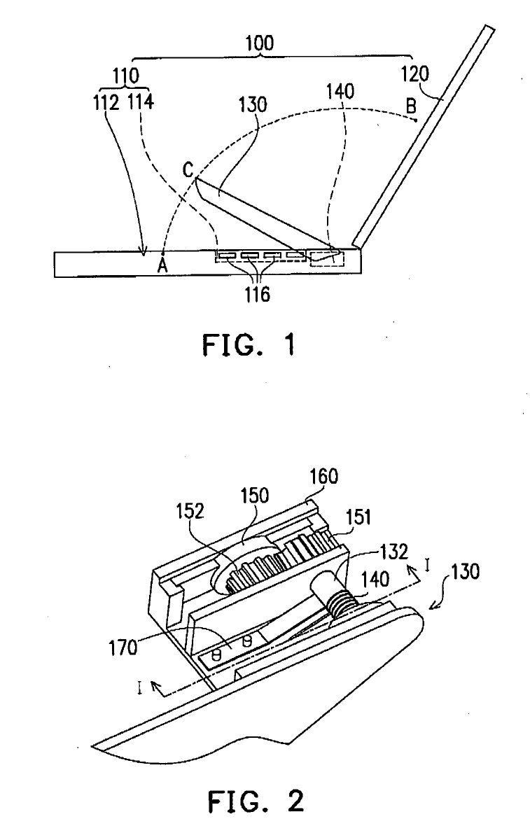

To protect a port of an electronic apparatus from dust and to resolve the problem that a cover cumbers the plugging of a plug of a peripheral equipment into the port, the present invention provides an electronic apparatus with a rotatable cover, and embodiments of the present invention will be described in detail with reference to FIGS. 1, 2, 3, 4, and FIGS. 5A-5F.

FIG. 1 is a side view of an electronic apparatus according to an embodiment of the present invention. Referring to FIG. 1, the electronic apparatus 100 includes a first body 110, a cover 130, and a restoring element 140. The first body 110 has at least one sidewall 112 and an opening 114 on the sidewall 112. At least a part of the cover 130 passes through the sidewall 112 and is pivoted to the first body 110. There is an endpoint C at one end of the cover 130, and the arc AB in FIG. 1 is the path of the endpoint C when the cover 130 rotates.

When the endpoint C is at point A, namely, the cover 130 is at a first position, the cover 130 covers the opening 114. When the endpoint C is at point B, namely, the cover 130 is at a second position, the cover 130 exposes the opening 114. The restoring element 140 is disposed in the first body 110, and the restoring element 140 imposes an elastic force to the cover 130 so that the endpoint C of the cover 130 is moved from point A to point B along arc AB, namely, the cover 130 is rotated from the first position to the second position by the elastic force.

As shown in FIG. 1, the opening 114 of the first body 110 is an electric connector opening. The first body 110 has a plurality of electric connectors 116 located in the opening 114. The electric connectors 116 may also be power ports for power supply besides the ports described in the conventional technology. Thus, one of the electric connectors 116 may be a network cable port, a modem port, a parallel port, a serial port, an universal serial bus (USB) port, a PS/2 ports, a video output port, a removable media port, a S-video ports, a headset port for connecting a headset, a microphone port for connecting a microphone, a memory card port, or a power port for power supply.

The electronic apparatus 100 in the present invention may be an electronic apparatus having one or more of the foregoing electric connectors, such as a notebook PC, a desktop PC, a personal digital assistant (PDA), or a cell phone. The electronic apparatus 100 of the present embodiment in FIG. 1 is a notebook PC which further includes a second body 120 pivoted to the first body 110. However, FIG. 1 only illustrates an embodiment of the electronic apparatus in the present invention, but does not limit the present invention.

FIG. 2 is a diagram illustrating a part of the first body and the cover in FIG. 1. Referring to FIG. 2, the electronic apparatus 100 further includes a first gear 151, a damper 150, a base 160, and an elastic strip 170, and the cover 130 further includes a shaft 132.

The first gear 151 fits the shaft 132. When the cover 130 rotates, the shaft 132 rotates along with the cover 130, meanwhile, the shaft 132 brings along the first gear 151 to rotate. Contrarily, when the first gear 151 rotates, the shaft 132 is rotated by the first gear 151, and accordingly the cover 130 is rotated.

The damper 150 has a second gear 152 engaged with the first gear 151. There is oil inside the damper 150. When the second gear 152 rotates, the oil in the damper 150 cumbers the rotation of the second gear 152, so as to reduce the rotate speed of the second gear 152. Since the second gear 152 is engaged with the first gear 151, the rotate speed of the first gear 151 is further reduced by the damper 150. Because the rotate speed of the first gear 151 is reduced, the rotation of the cover 130 is slowed down accordingly, so that the cover 130 can be prevented from being crashed, or being collided with the second body 120 that produces noise. Besides the damper 150 in FIG. 2, a third gear bigger and/or heavier than the first gear 151 can be used as the damper in other embodiments. In the present embodiment, the damper 150 in FIG. 2 is only described as an example but not for limiting the present invention.

The base 160 is disposed in the first body 110, and the main function of the base 160 is to provide a place for disposing the first gear 151, the second gear 152, and the elastic strip 170. The shaft 132 passes through at least a part of the base 160, and then the shaft 132 is fitted by the first gear 151 so as to pivot the cover 130 to the first body 110.

The restoring element 140 surrounds the shaft 132, and as shown in FIG. 2, the restoring element 140 is a torsional spring surrounding the shaft 132. When the cover 130 is rotated from the second position to the first position, the restoring element 140 produces deformation due to the affection of the torsional force produced by the shaft 132. The deformed restoring element 140 produces an elastic force to resist the torsional force from the shaft 132. When the elastic force of the restoring element 140 is greater than the torsional force of the shaft 132, the elastic force of the restoring element 140 rotates the cover 130 from the first position to the second position. In the present embodiment, the restoring element 140 in FIG. 2 is only described as an example but not for limiting the present invention.

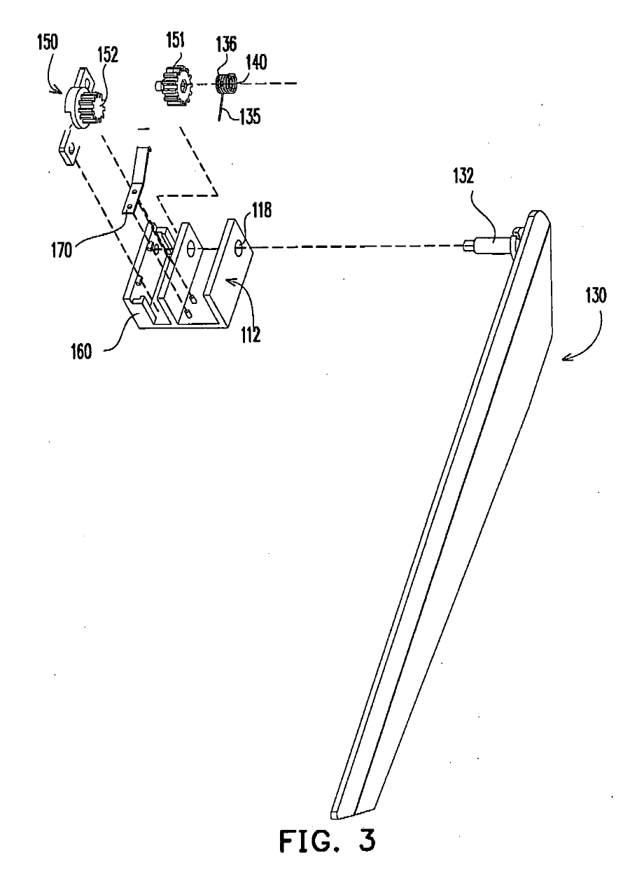

FIG. 3 is an explosion diagram of the part of the first body and the cover in FIG. 2. Referring to FIG. 3, the sidewall 112 of the first body 110 further includes a hole 118. The shaft 132 passes through the hole 118 and is surrounded by the restoring element 140. A first contact end 135 of the restoring element 140 is in contact with the first body 110, and a second contact end 136 of the restoring element 140 is in contact with the shaft 132. By contacting the first contact end 135 against the base 160 and the second contact end against the shaft 132, the restoring element 140 surrounds the shaft 132, and at the same time, the restoring element 140 can impose an elastic force to the shaft 132 so as to rotate the cover 130.

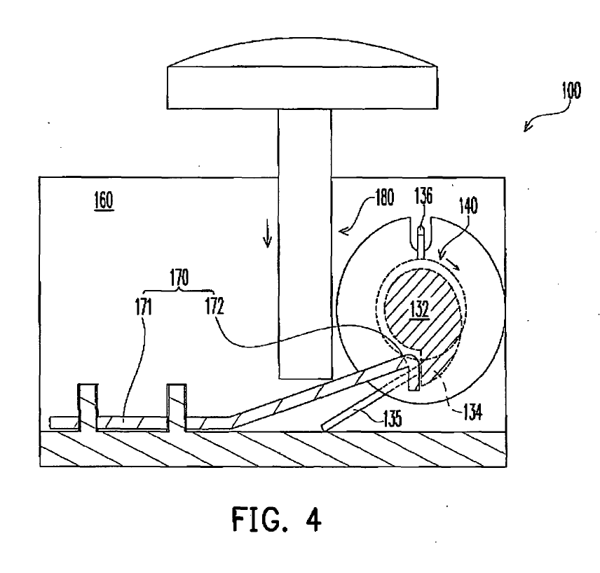

FIG. 4 is a cross-sectional view of the part of the first body and the cover in FIG. 2 taken along line I-I. Referring to FIG. 4, the electronic apparatus 100 further includes a button 180, and the shaft 132 further includes a locking portion 134. The main function of the button 180, the locking portion 134, and the elastic strip 170 is to start or stop the rotation of the shaft 132.

The button 180 is disposed on the first body 110. A first end 171 of the elastic strip 170 is fixed to the base 160 in the first body 110. When the cover 130 is at a first position, i.e., the endpoint C of the cover 130 is at point A (referring to FIG. 1), and a second end 172 of the elastic strip 170 is at the locking portion 134. The shaft 132 is driven by the elastic force of the restoring element 140 to rotate and which further drives the locking portion 134 to rotate towards the second end 172 (in FIG. 4, the shaft 132 driven by the elastic force rotates clockwise). However, the locking portion 134 rotated by the elastic force is resisted by the second end 172 so that the locking portion 134 is fixed, and accordingly the cover 130 is fixed at the first position.

To move the cover 130 from the first position to the second position, namely, to move the endpoint C of the cover 130 from point A to point B (referring to FIG. 1), the button 180 is pressed downward so that the tilted second end 172 is pressed down by the button 180 and is released from the locking portion 134. The shaft 132 driven by the elastic force is not resisted by the second end 172, so that the shaft 132 can rotate (in FIG. 4, the shaft 132 rotates clockwise), and accordingly, the cover 130 is rotated from the first position to the second position.

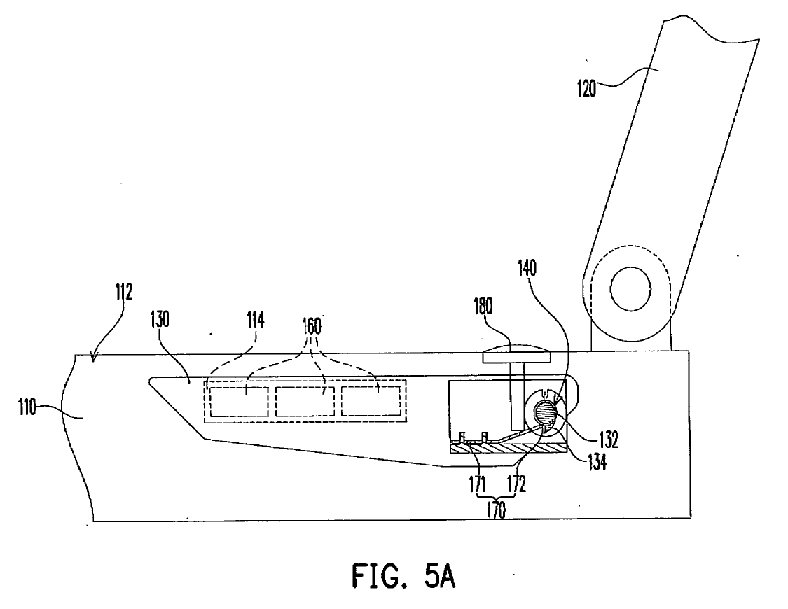

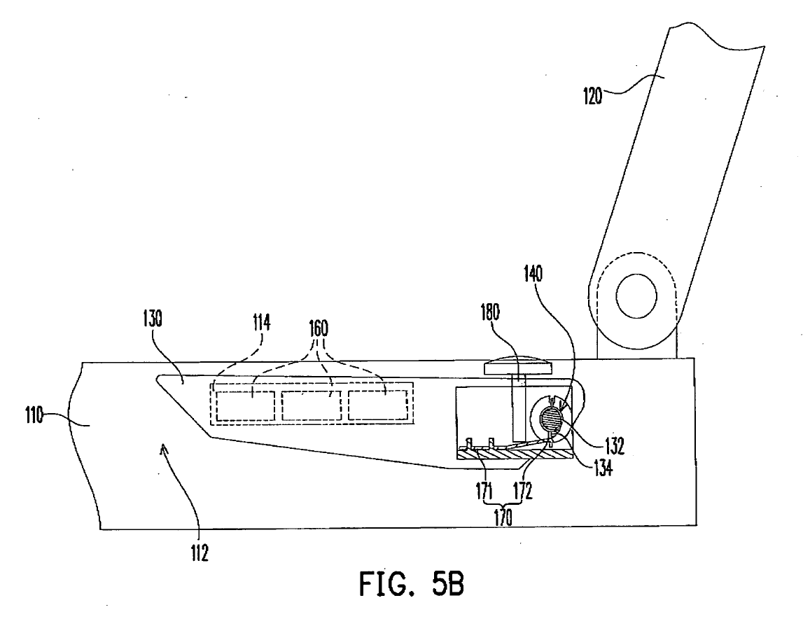

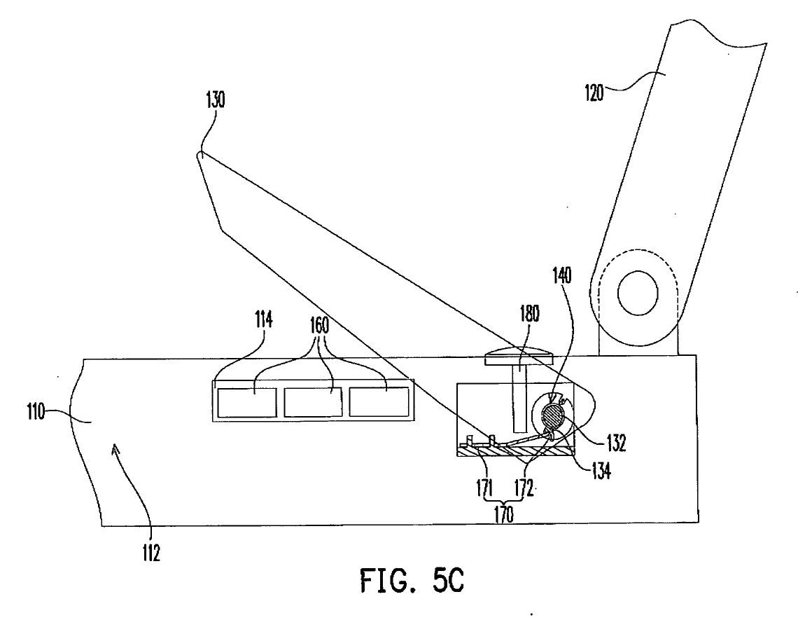

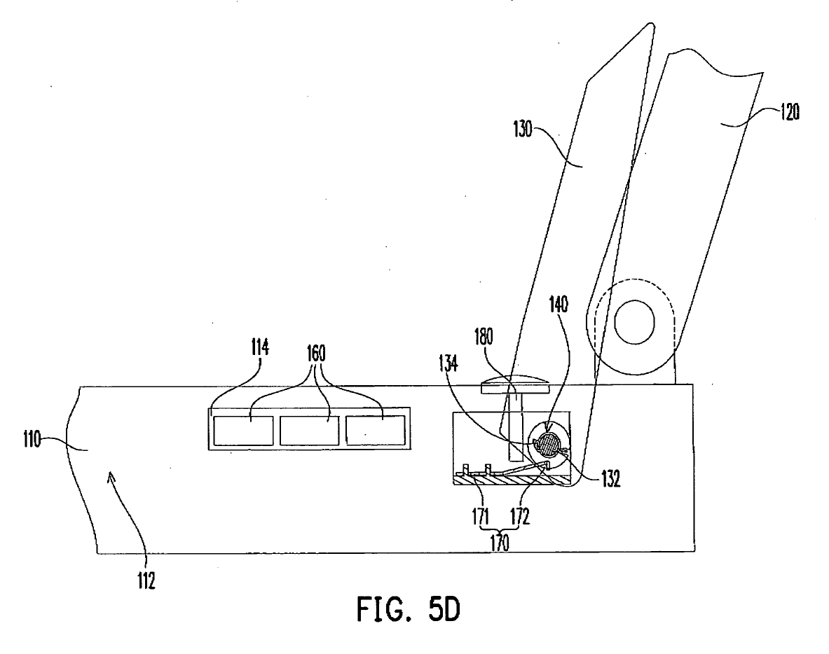

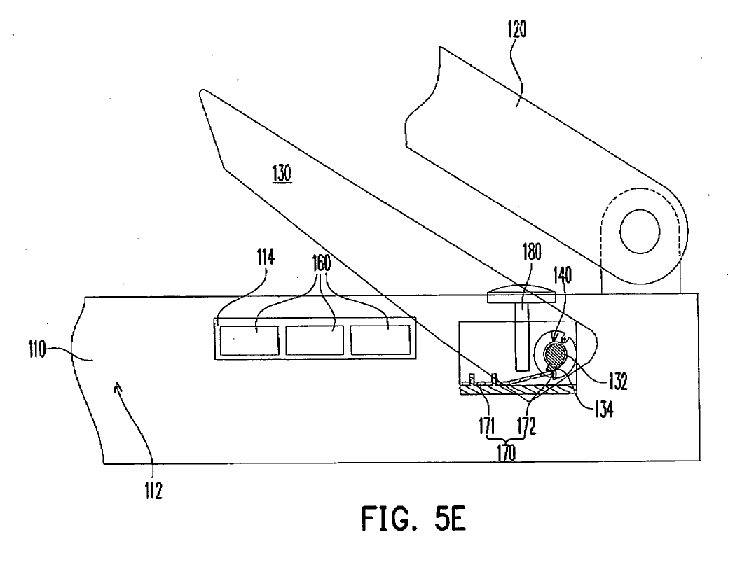

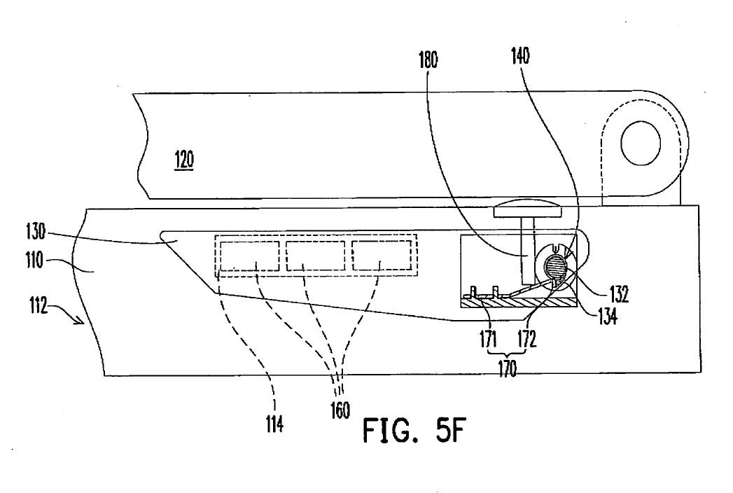

FIGS. 5A-5F are diagrams illustrating the operation of the cover. Refer to FIGS. 5A-5F in sequence. In FIG. 5A, the cover 130 is at the first position, and the button 180 is at the third position. The cover 130 is fixed to the first position since the second end 172 is at the locking portion 134.

Referring to FIG. 5B, even though when the button 180 is pressed downward from the third position to the fourth position, the button 180 pushes the elastic strip 170 down to release the elastic strip 170 from the locking portion 134. Here the cover 130 starts to rotate from the first position.

Referring to FIG. 5C, after the second end 172 is released from the locking portion, the cover 130 is affected by the elastic force from the restoring element 140 to rotate (in FIG. 5B, the cover 130 rotates clockwise). Here the button 180 is affected by the elastic force from the elastic strip 170 to restore to the third position.

Referring to FIG. 5D, the cover 130 is at the second position. The cover 130 driven by the elastic force keeps rotating until it rotates to the second position. Here, the opening 114 of the first body 110 is exposed so that one of the electric connectors 116 in the opening 114 can be connected with a plug of a peripheral equipment or a power supply cable.

Referring to FIG. 5E, since the cover 130 moves in relative to the second body 120, that is, the cover 130 rotates along with the rotation of the second body 120 in relative to the first body, the cover 130 rotates from the second position to the first position along with the second body 120 when the second body 120 rotates towards the first body 110.

Referring to FIG. 5F, when the second body 120 keeps rotating until the second body 120 and the first body 110 are brought face to face, the second end 172 of the elastic strip 170 is at the locking portion 134, so that the locking portion 134 is resisted by the second end 172, and accordingly the cover 130 is fixed to the first position.

In overview, according to the electronic apparatus with a rotatable cover in the present invention, the cover 130 pivoted to the first body 110 is used for covering the opening 114, so that the electric connectors 116 in the opening 114 are protected from dust. Besides, since the cover 130 rotates with the shaft 132 as its axis, the opened cover 130 will not be located between the plug of a peripheral equipment to be plugged (not shown) and the opening 114, so that the cover 130 will not block the plug of the peripheral equipment and the opening 114. Accordingly, the plug of the peripheral equipment can be easily plugged into an electric connector 116 in the opening 114.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An electronic apparatus, comprising:
a first body, having at least one sidewall and an opening disposed on the sidewall;
a cover, at least a part of the cover passing through the sidewall and being pivoted to the first body, when the cover is at a first position, the cover covers the opening, and when the cover is at a second position, the cover exposes the opening; and
a restoring element, disposed in the first body, imposing an elastic force to the cover to rotate the cover from the first position to the second position.

2. The electronic apparatus as claimed in claim 1, wherein the opening is an electric connector opening.

3. The electronic apparatus as claimed in claim 1 further comprising a second body pivoted to the first body.

4. The electronic apparatus as claimed in claim 3, wherein the cover rotates along with the rotation of the second body relative to the first body.

5. The electronic apparatus as claimed in claim 1, wherein the cover further comprises a shaft, the sidewall further comprises a hole, the shaft passes through the hole, the restoring element is pivoted to the shaft, a first contact end of the restoring element is in contact with the first body, and a second contact end of the restoring element is in contact with the shaft.

6. The electronic apparatus as claimed in claim 5 further comprising at least one first gear pivoted to the shaft and one second gear disposed in the first body, the first gear being engaged with the second gear.

7. The electronic apparatus as claimed in claim 6 further comprising a base, the first gear and the second gear being disposed on the base, the shaft passing through at least a part of the base.

8. The electronic apparatus as claimed in claim 6, wherein the second gear is a gear of a damper.

9. The electronic apparatus as claimed in claim 5 further comprising an elastic strip and a button, wherein the shaft further comprises a locking portion, the button is disposed on the first body, a first end of the elastic strip is fixed in the first body, when the cover is at the first position, a second end of the elastic strip is at the locking portion, and when the button is pressed downward from a third position to a fourth position, the button pushes the elastic strip down so that the second end of the elastic strip is released from the locking portion, the cover rotates to the second position.

10. The electronic apparatus as claimed in claim 5, wherein the restoring element is a torsional spring surrounding the shaft.
